(19) United States
(12) Patent Application Publication
(10) Pub. No.: US 2005/0228890 A1
(43) Pub. Date: Oct. 13, 2005

(54) System for managing operating sessions of an executable application

(76) Inventor: Brian Lawrence, Perkasie, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/103,377

(22) Filed: Apr. 11, 2005

Related U.S. Application Data
(60) Provisional application No. 60/561,221, filed on Apr. 9, 2004.

(51) Int. Cl. G06F 15/16; G06F 13/00; G06F 9/44

(52) U.S. Cl. 709/227; 719/320

(57) ABSTRACT

A system manages operating sessions of an executable application initiated via a browser application on a workstation. The system includes a detector, a monitor, a communicator, and a command processor. The detector detects initiation of a first operational session of an executable application on a workstation, wherein the initiation occurs in response to user activation of a displayed URL link. The monitor determines whether a previously initiated second operational session of the executable application is concurrently operational on the workstation by comparing a portion of the URL with stored data representing one or more URLs corresponding to one or more executable applications currently operational on the workstation. The command processor redirects the first operational session to a URL of the previously initiated second operational session of the executable application in response to a URL match determined by the comparison. The communicator terminates establishment of the first operational session.

### CROSS-REFERENCE TO RELATED APPLICATIONS

The present application is a non-provisional application of provisional application having Ser. No. 60/561,221 filed by Brian Lawrence on Apr. 9, 2004.

### FIELD OF THE INVENTION

The present invention generally relates to computer information systems. More particularly, the present invention relates to a system for managing operating sessions of an executable application.

### BACKGROUND OF THE INVENTION

The World Wide Web (i.e., the Web) provides a way to access information over the Internet using one of several protocols (e.g., hypertext transmission protocol (HTTP)).

Web browsers, such as the Internet Explorer® or Netscape® browsers, access Web documents called Web pages. Typically, Web browsers are graphical browsers, which means that they can display graphics, audio, text, and/or video files in the Web documents.

The Web documents are formatted in a markup language called hypertext markup language (HTML) that supports links to other Web documents. A Web browser permits a user to jump (i.e., link or transfer) from one Web document to another Web document by clicking (i.e., selecting) a hyperlink, which identifies particular information or an area in a Web document that is linked to another Web document.

In a system, such as a workstation, for example, a first executable application hosting a first embedded Web browser may need to navigate to a second executable application hosting a second embedded Web browser in response to a user selecting a universal resource locator (URL) link displayed in the first executable application. Typically, the system displays a web document, corresponding to the URL link, in a separate window, generated by a stand-alone browser, overlaying the two windows of the first and second executable applications. Although the separate window displays the retrieved web document, the separate window disrupts the user interface experience for the user of the system. Problems with the user interface experience include, for example, the separate window blocking the view of the underlying two windows, inefficient user selection between the separate window and one of the underlying two windows, and the separate window needing to be closed by the user when the user finishes working in the separate window. Accordingly, there is a need for a system for managing operating sessions of an executable application, which overcomes these and other disadvantages of the prior systems.

### SUMMARY OF THE INVENTION

A system manages operating sessions of an executable application initiated via a browser application on a workstation. The system includes a detector, a monitor, a communicator, and a command processor. The detector detects initiation of a first operational session of an executable application on a workstation, wherein the initiation occurs in response to user activation of a displayed URL link. The monitor determines whether a previously initiated second operational session of the executable application is concurrently operational on the workstation by comparing a portion of the URL with stored data representing one or more URLs corresponding to one or more executable applications currently operational on the workstation. The command processor redirects the first operational session to a URL of the previously initiated second operational session of the executable application in response to a URL match determined by the comparison. The communicator terminates establishment of the first operational session.

### BRIEF DESCRIPTION OF THE DRAWINGS

FIG. 1 illustrates a system for managing operating sessions of an executable application.

FIG. 2 illustrates a method performed by the system, as shown in FIG. 1.

FIG. 3 illustrates a conceptual flow diagram for the system, as shown in FIG. 1, and the method, as shown in FIG. 2.

FIG. 4 illustrates a window for the first executable application, as shown in FIG. 1, displayed in a composite window of a software platform, as shown in FIG. 1.

FIG. 5 illustrates a window for the stand-alone browser, as shown in FIG. 1, displayed over a composite window of a software platform, as shown in FIG. 1.

FIG. 6 illustrates a window for the second executable application, as shown in FIG. 1, displayed in a composite window of a software platform, as shown in FIG. 1.

### DETAILED DESCRIPTION OF THE PREFERRED EMBODIMENTS

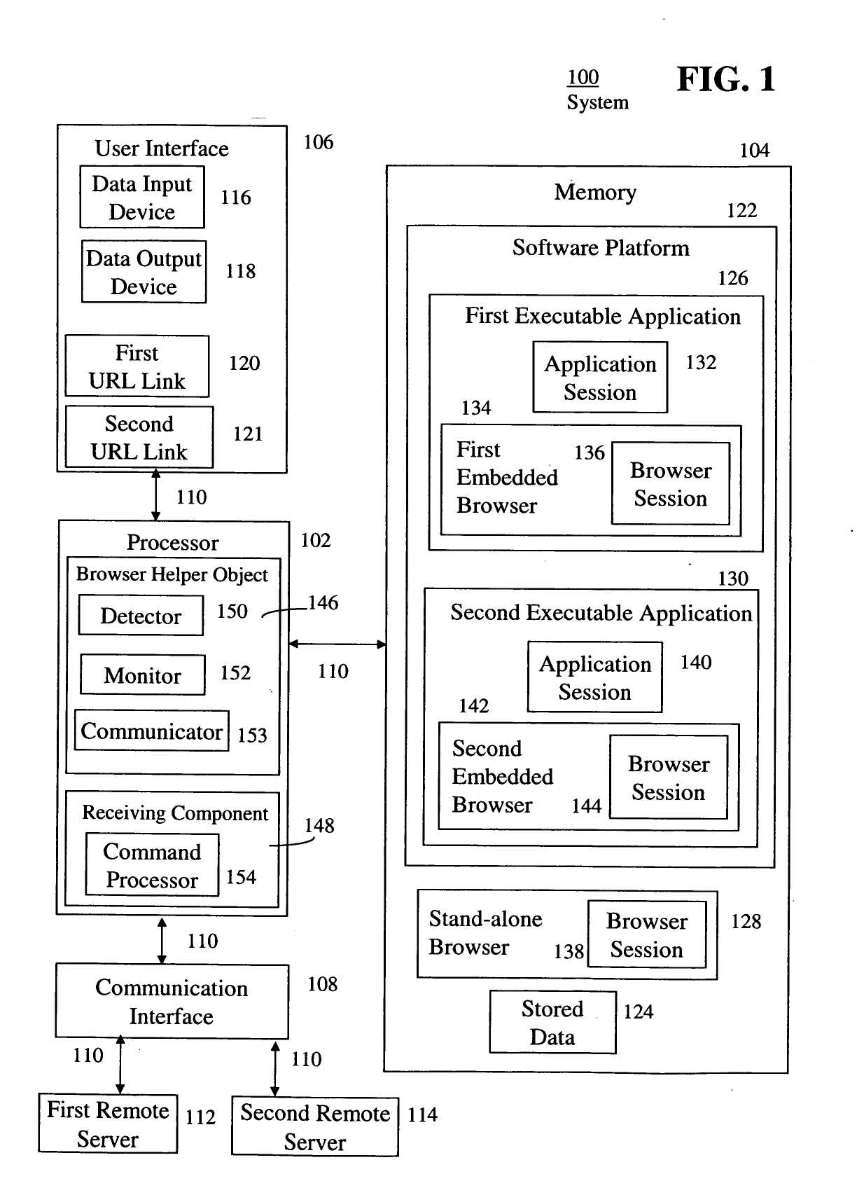

FIG. 1 illustrates a system 100 (e.g., a workstation) for managing operating sessions 132, 136, 140, and 144 of an executable application 122. The system 100 includes a processor 102, a memory 104, a user interface 106, a communication interface 108, and a communication path 110. The processor 102 is electrically coupled to each of the memory 104, the user interface 106, and the communication interface 108 over the communication path 110. The system 100 interfaces to a first remote server 112 and a second remote server 114 via the communication interface 108 over the communication path 110.

The user interface 106 further includes a data input device 116, a data output device 118, and includes a first universal resource locator (URL) link 120 and a second URL link 121.

The memory 104 further includes a parent application 122, a stand-alone browser 128 having a browser session 138, and stored data 124. The parent application 122 further includes a first executable application 126 and a second executable application 130. The first executable application 126 has an application session 132 and includes a first embedded browser 134 having a browser session 136. The second executable application 130 has an application session 140 and includes a second embedded browser 142 having a browser session 144.

The processor 102 further includes a browser helper object (BHO) 146 and a receiving component 148. The browser helper object 146 further includes a detector 150, a monitor 152, and a communicator 153. The receiving component 148 further includes a command processor 154.

The system 100 may be employed by any type of enterprise, organization, or department, such as, for example, providers of healthcare products and/or services responsible for servicing the health and/or welfare of people in its care. For example, the system 100 represents a hospital information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 and/or elements contained therein also may be implemented in a centralized or decentralized configuration.

The communication path 110 (otherwise called network, bus, link, connection, channel, etc.) represents any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 106 permits data to be received by or received from the processor 102. The data input device 116 provides data to the processor 102 in response to receiving input data either manually from a user or automatically from an electronic device, such as a computer. For manual input, the data input device 116 is a keyboard and a mouse, but also may be a touch screen, or a microphone with a voice recognition application, for example. For automatic input, the data input device 116 is a data modem.

The data output device 118 provides data from the processor 102 for use by a user or an electronic device, such as a computer. For output to a user, the data output device 118 is a display that generates display images in response to receiving the display signals from the processor, but also may be a speaker or a printer, for example. For electronic output to an electronic device, the data output device 118 is a data modem. For example, the processor 102 processes the medical image information for reproduction on a display device for viewing by a user.

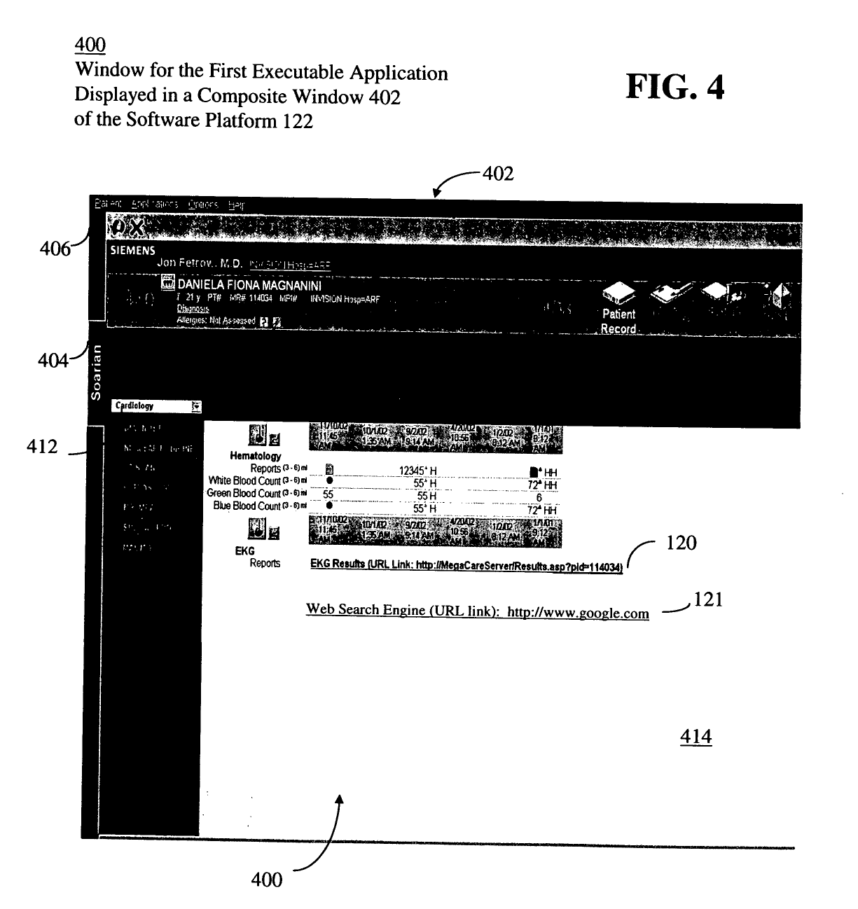

The data output device 118 displays the URL link 120 and/or 121, as shown in FIG. 4, which is selectable by a user via the data input device 116. The Web identifies Web pages by corresponding unique URLs. A URL provides a global address for computers to identify and access Web documents and other resources on the Web. The first part of the address indicates what protocol to use (e.g., “http://”), and the second part of the address specifies the Internet Protocol (IP) address or the domain name (e.g., “www.siemens.com”) where the resource is located. For example, “http://www.siemens.com” specifies a Web page accessed using the HTTP protocol.

The communication interface 108 provides a boundary across which the system 100 and one or more other independent systems, such as the first remote server 112 and the second remote server 114, meet and act on or communicate with each other.

The memory 104 represents one or more numbers and/or types of repositories, databases, or data storage devices, such as, for example, read only memory (ROM) and/or random access memory (RAM).

The software platform 122 is a high-level executable application that runs on an operating system, such as Windows. Syngo® software platform, from Siemens Corp., for example, is a software platform for medical systems and applications, which integrates patient-related, physiological, and imaging data across a clinical workflow in a healthcare system. The Syngo® software platform advantageously provides a common, efficient, user interface for many medical applications. The Syngo® user interface is designed to minimize eye movement and mouse clicks, so that the medical applications are easy to use and improve productivity. The Syngo® software platform is built on a Windows NT/2000 platform.

An example of the first executable application 126 is a Soarian® application, as shown in FIG. 4, from Siemens Corp. The Soarian application is a web-based application designed to improve workflow, quality, and information sharing with a hospital and an integrated delivery network (IDN).

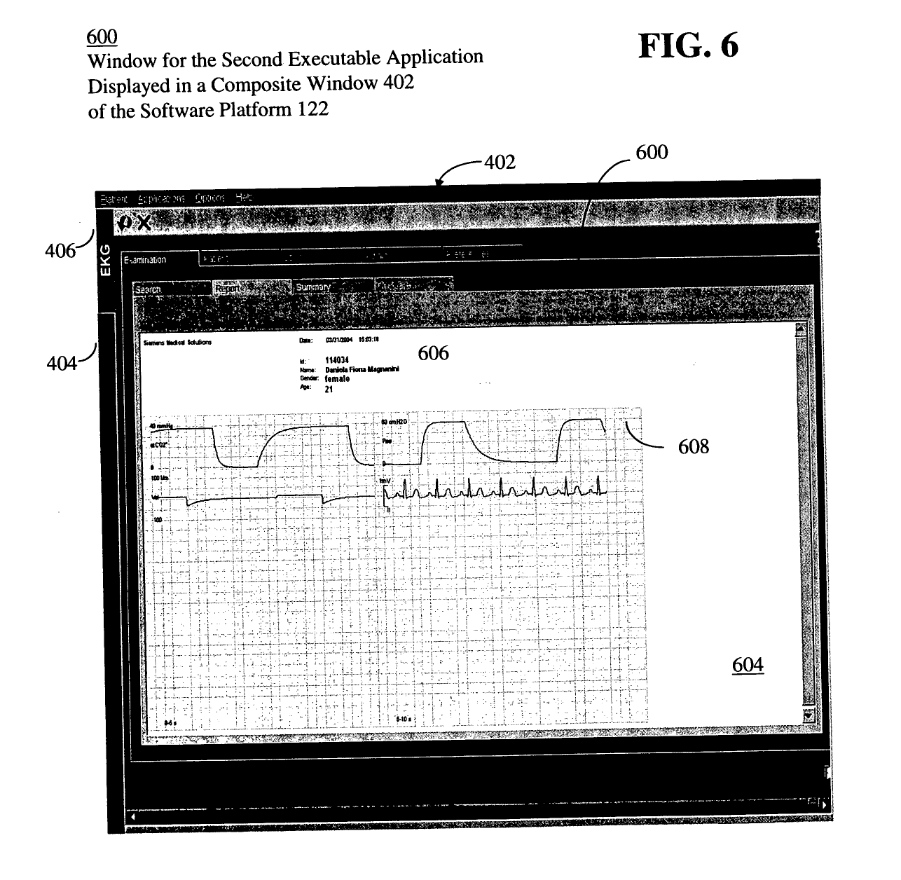

An example of the second executable application 130 is an Infinity® MegaCare application, as shown in FIG. 6, from Siemens Corp. The Infinity® MegaCare application is a web-based EKG management system designed with emphasis on performance, management and security, resulting in a solution that is technology strong and workflow smart. The Infinity MegaCare application stores EKG information from a wide range of popular electrocardiographs, Holter systems, exercise systems, ambulance systems, and patient monitoring systems. Standard features include physician notes, calipers, acronym lists, and management reporting. An HL7 interface imports patient demographics from the hospital admissions system. With the addition of an HL7 order management interface, requisitions can be automatically captured and, upon confirmation, order messages can be sent to patient accounting for billing.

Each of the executable applications 126, 130, and/or 122 comprise code or machine readable instruction for implementing predetermined functions including, for example, those of an operating system, a software application program, a healthcare information system, or other information processing system, for example, in response user command or input. For example, each of the executable applications 126 and 130 comprise code for running on the software platform 122, which is a high-level executable application itself.

The first 126 and second 130 executable applications, implemented with embedded browsers hosting web-based applications, communicate with and receive information from the first 112 and second 114 remote servers, respectively, in a client-server relationship.

Each of the executable applications 126 and 130 has an application session 132 and 140, respectively. An application session 132 is a mechanism for recognizing one or more requests from the same application. A separate application session exists for each separate application instance. Typically, each of the application sessions 132 and 140 is a session of activity that a user, with a unique IP address, spends in the executable applications 126 and 130, respectively, during a specified duration of time. In other words, an application session is a period of time that a user interfaces with an executable application. Typically, an application session begins when the user accesses an executable application and ends when the user quits the executable application.

Each of the first embedded browser 134, the second embedded browser 142, and the stand-alone browser 128 include browser sessions 136, 144, and 138, respectively. A browser session is a mechanism for recognizing one or more requests from the same browser. A separate browser session exists for each separate browser instance. Typically, each of the browser sessions 136, 144, and 138 is a session of activity that a user, with a unique IP address, spends on a Web site during a specified duration of time. In other words, a browser session is a period of time that a user interfaces with a Web site. Typically, a browser session begins when the user accesses a Web site and ends when the user quits the Web site.

Because the executable applications 126 and 130 host the first 134 and second 130 embedded browsers, respectively, the definition for the application sessions overlap with the definition of the browser sessions. Hence, at some level an application session is difficult to distinguish from a browser session. The application session and the browser session, each alone or together, may be considered as an operational session.

Web browsers may be embedded (i.e., integrated) into an executable application or stand-alone (i.e., independent) of an executable application. The embedded browsers 134 and 142 are integrated into and hosted by executable applications 126 and 130, respectively. The standalone browser application 128 is independent of the functionality of executable applications 126 and 130. Various business, engineering, user interface, and legal issues, etc., such as, for example, cost, feature upgrades, and performance present various tradeoffs for each of the embedded and stand-alone configurations.

The stored data 124 represents one or more URLs including the protocol and/or the IP address. The URL link may include one or more of the following information: words, phrases, character strings, numbers, symbols, and punctuation. In particular, the stored data 124 represents one or more URLs, corresponding to multiple overlaid tabbed web page windows 400 and 600, as shown in FIGS. 4 and 6, corresponding to multiple executable applications 126 and 130. The multiple overlaid tabbed web page windows 400 and 600 include visible tabs 404 and 406, as shown in FIGS. 4 and 6, respectively, incorporating an identifier identifying the respective web pages.

The system 100 and/or elements contained therein may be implemented in hardware, software, or a combination of both, and may include one or more processors. The processor 102 is a device and/or set of machine-readable instructions for performing task. The processor 102 includes any combination of hardware, firmware, and/or software. The processor 102 acts upon stored and/or received information by computing, manipulating, analyzing, modifying, converting, or transmitting information for use by an executable application or procedure or an information device, and/or by routing the information to an output device. For example, the processor 102 may use or include the capabilities of a controller or microprocessor.

Generally, the system 100 detects, monitors, communicates, and controls the navigation of the first executable application 126, hosting the first embedded browser 134, to the second executable application 130, hosting the second embedded browser 142, via the stand-alone browser 128, in response to a user selecting a universal resource locator (URL) link 120 displayed in the first executable application 126. The system 100 is particularly useful in a proprietary environment, for example, where executable applications need control over which URLs a user is permitted to navigate to.

In the processor 102, the browser helper object (BHO) 146 is implemented, for example, as a dynamic link library (DLL) file, which is a library of executable functions or data that can be used by a Windows® software application. Typically, a DLL file provides one or more particular functions, and a program accesses the functions by creating either a static or dynamic link to the DLL file. A static link remains constant during program execution. The program creates a dynamic link, as needed. DLL files can also contain just data. DLL files usually end with an extension such as, for example, dll, exe, drv, or fon. A DLL file can be used by several software applications at the same time. Some DLL files are provided with the Windows operating system, and available for any Windows software application. Other DLL files are written for a particular software application, and are loaded with the software application.

The stand-alone browser 128 loads the BHO 146 for a new browser session of the stand-alone Web browser 128. Hence, the BHO 146 communicates with the stand-alone browser 128, thereby permitting the BHO 146 to detect, monitor, and/or communicate activity associated with the stand-alone browser 128 and to communicate with the receiving component 148.

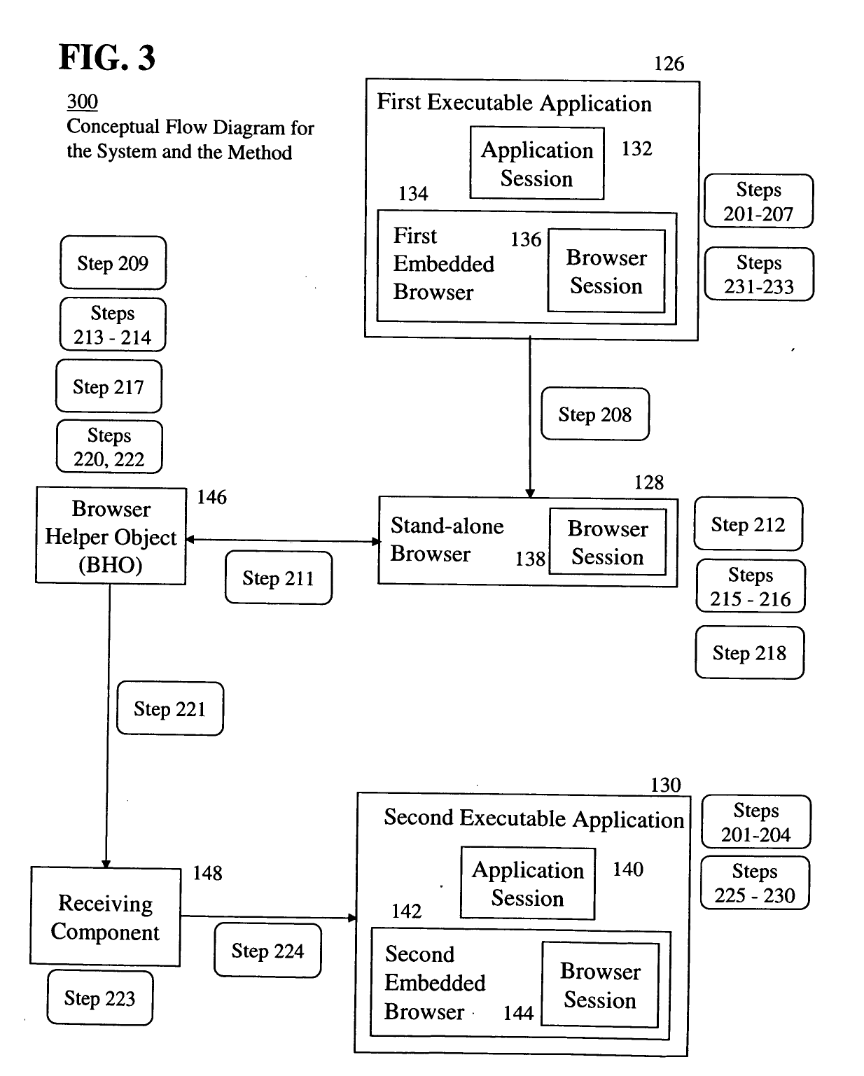

In the processor 102, the receiving component 148 communicates with the BHO 146 and the second executable application 130. Various combinations of functions of the BHO 146 and the receiving component 148 may be allocated among) the BHO 146 and the receiving component 148, if required or desired. FIG. 3 describes further details of the relationships among the first executable application 126, the second executable application 130, the stand-alone browser 128, the BHO 146, and the receiving component 148.

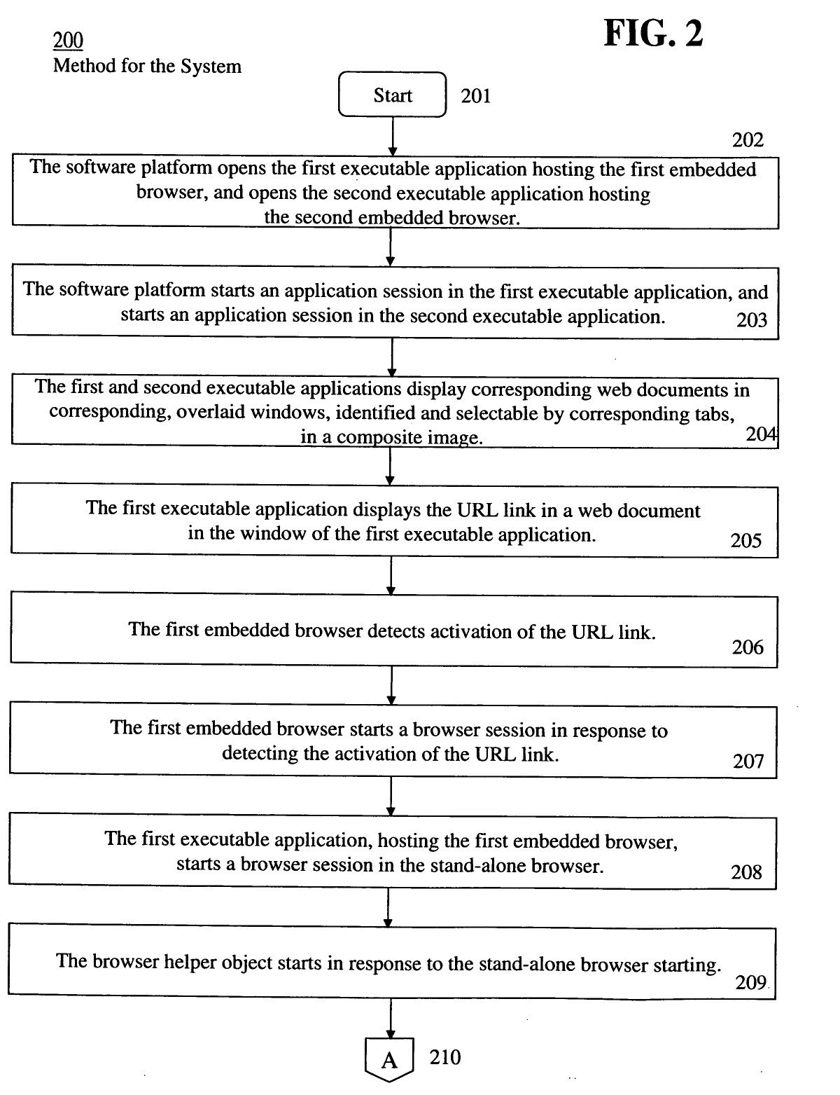

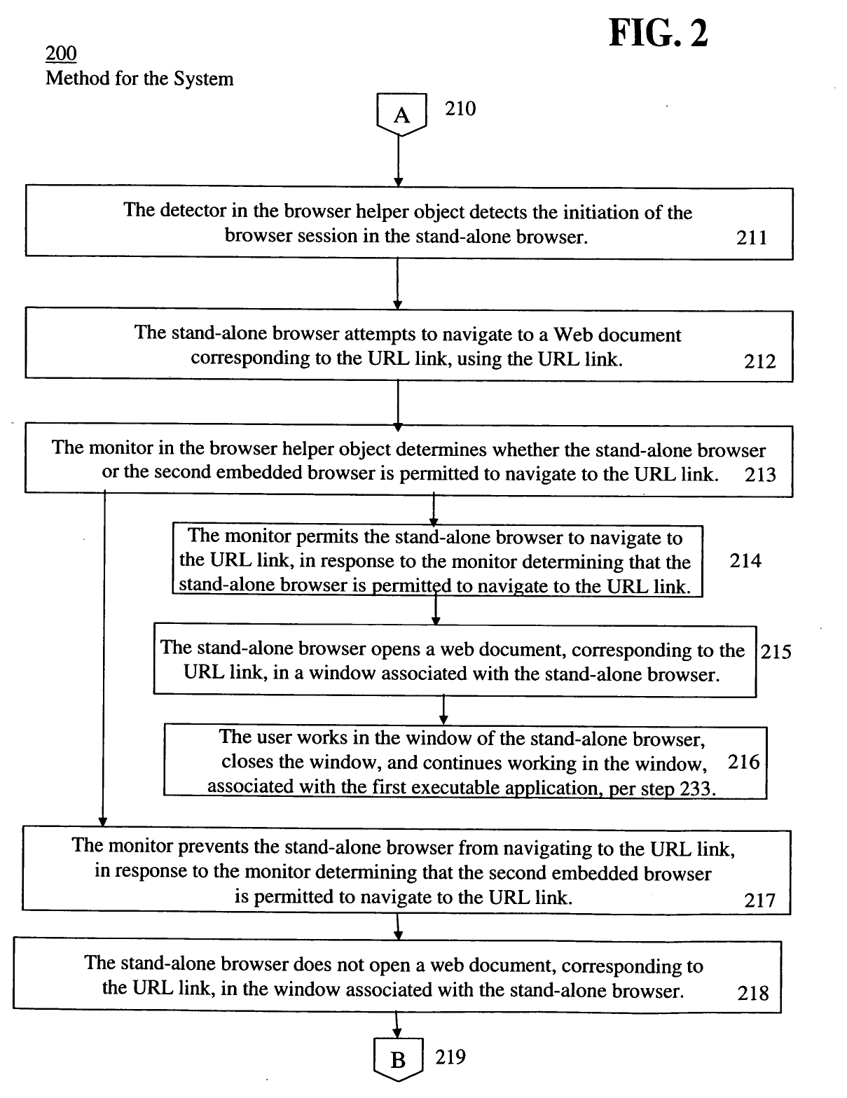

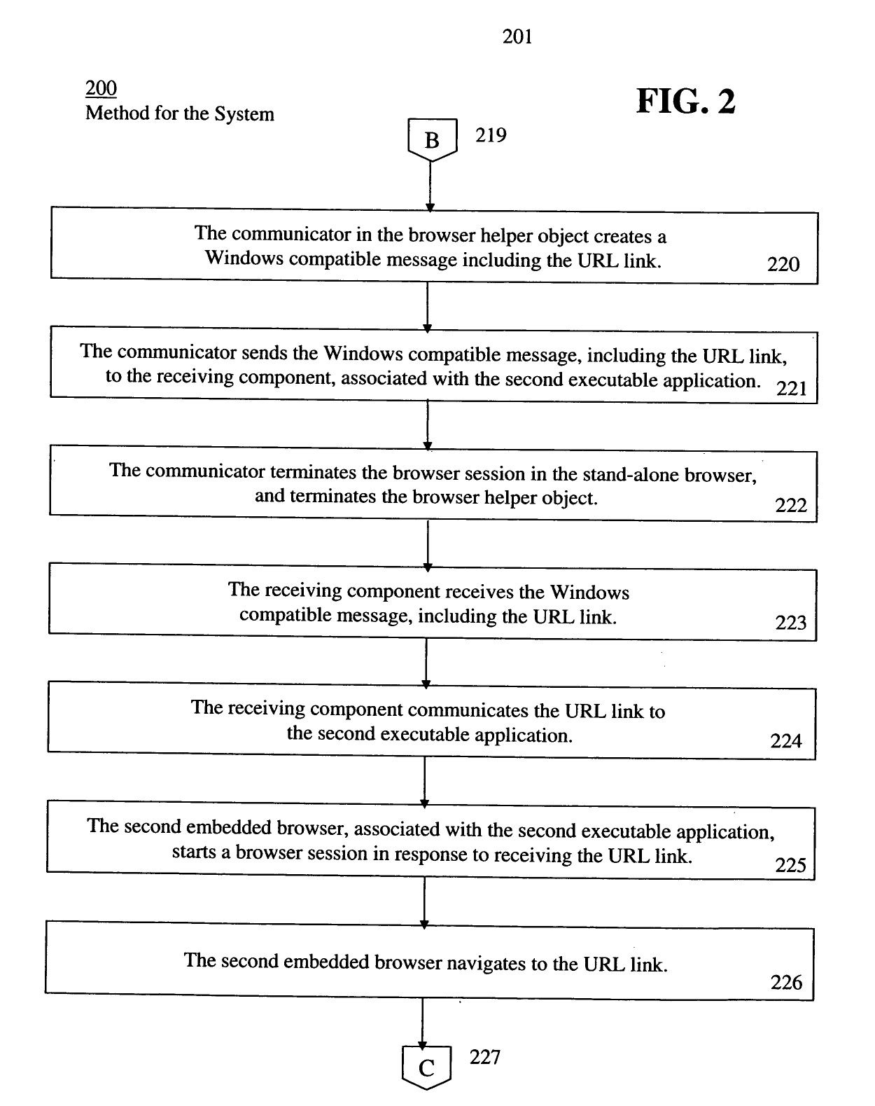

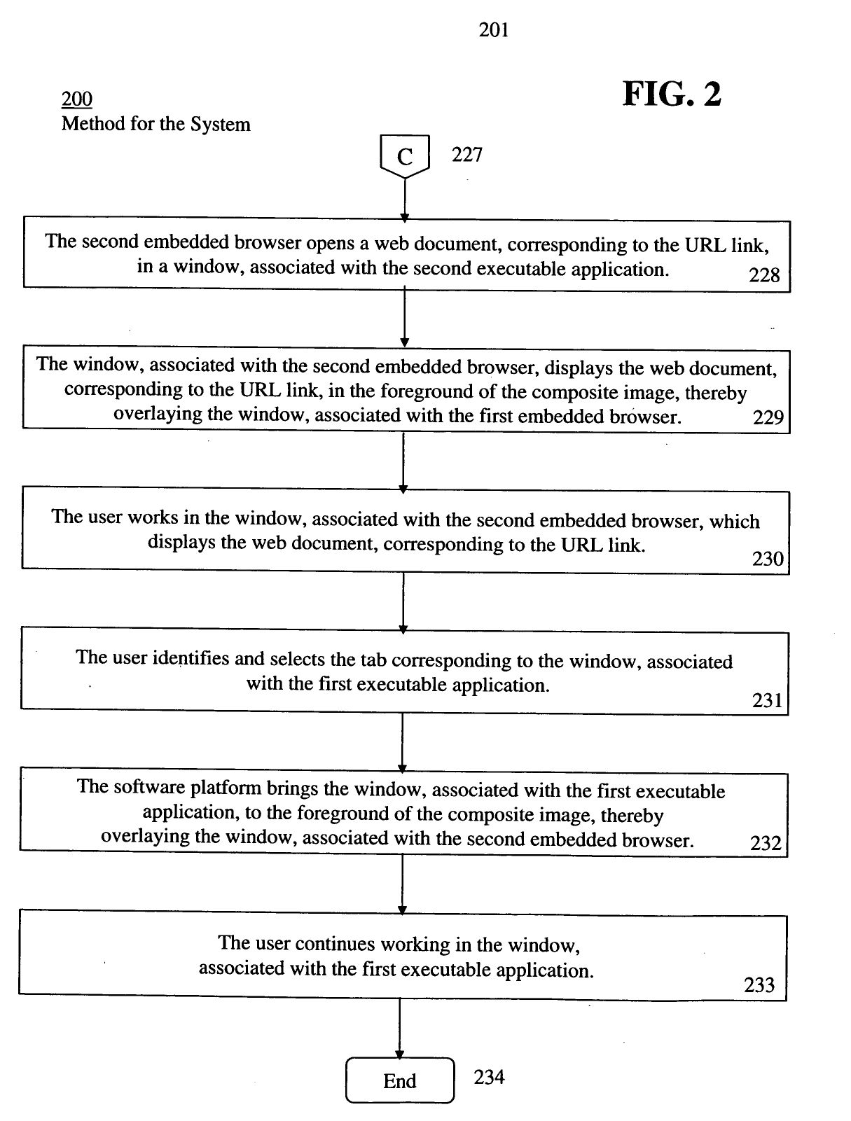

FIG. 2 illustrates a method 200 performed by the system 100, as shown in FIG. 1.

At step 201, the method starts.

At step 202, the software platform 122 opens the first executable application 126 hosting the first embedded browser 134, and opens the second executable application 130 hosting the second embedded browser 142.

At step 203, the software platform 122 starts an application session 132 in the first executable application 122, and starts an application session 140 in the second executable application 130.

At step 204, the first 126 and second 130 executable applications display corresponding web documents in corresponding, overlaid windows 400 and 600, as shown in FIGs. 4 and 6, respectively, identified and selectable by corresponding tabs 404 and 406, as shown in FIGS. 4, 5 and 6, in a composite image 402, as shown in FIGS. 4, 5, and 6, of the software platform 122. When the software platform 122 opens 202, starts 203, and displays 204 both of the first 126 and second 130 executable applications at the same time, the applications 126 and 130 are described as concurrently operational so that both applications 126 and 130 are ready and available for the convenience of the user. Alternatively, only one of the executable applications 126 and 130 is open, started, and displayed at a time.

At step 205, the first executable application 126 displays the URL link 120 and/or 121 in a display area 414 in the window 400 of the first executable application 126.

At step 206, the first embedded browser 134 detects activation of the URL link 120 or 121, in response to a user selecting the URL link 120 or 121.

At step 207, the first embedded browser 134 starts a browser session 136 in response to detecting the activation of the URL link 120 or 121.

At step 208, the first executable application 126, hosted by the first embedded browser 134, starts a browser session 138 in the stand-alone browser 128. The browser session 138 of the stand-alone browser 128 includes, for example, a replicated instance of the first embedded browser 134. Alternatively, browser session 138 of the stand-alone browser 128 includes a replicated instance of an executable application accessed via a browser.

At step 209, the browser helper object (BHO) 146 starts in response to the stand-alone browser 128 starting. In particular, in response to the initiation of the BHO 146, the BHO 146 reads an initialization file located in a configuration directory (not shown in the memory 104). The initialization file contains, for example: the list of URLs that the BHO 146 responds to, a name of the corresponding executable applications, a name to communicate with, a handle name used to determine a parent window for the executable application, and an amount or number of navigations the BHO 146 detects and monitors in each browser session of the stand-alone browser 128 before the BHO 146 stops detecting and monitoring.

At step 210, the method 200 continues from step 209 to step 211 between pages.

At step 211, the detector 150 in the browser helper object 146 detects the initiation of the browser session 138 in the stand-alone browser 128.

At step 212, the stand-alone browser 128 attempts to navigate to a Web document corresponding to the URL link 120 or 121, using the URL link 120 or 121, respectively.

At step 213, the monitor 152 in the browser helper object 146 determines whether the stand-alone browser 128 or the second embedded browser 142 is permitted to navigate to the URL link 120 or 121. The monitor 152 makes this determination by comparing at least a portion of the URL link 120 or 121 with the stored data 124, representing one or more URLs corresponding to one or more executable applications. For example, the monitor 114 compares the portion of the URL link 120 or 121 with stored data 124, representing one or more URL links, by comparing information in the two URL links including the protocol and/or the IP address. The information in the two URL links includes, for example, one or more of the following information: words, phrases, character strings, numbers, symbols, and punctuation.

At step 214, the monitor 152 permits the stand-alone browser 128 to navigate to the destination web page corresponding to the URL link 120, in response to the monitor 152 determining that the stand-alone browser 128 is permitted to navigate to the URL link 121. A permitted determination may be made in response to a URL match determined by the comparison or in response to the URL link 121 not being prevented as determined by the comparison.

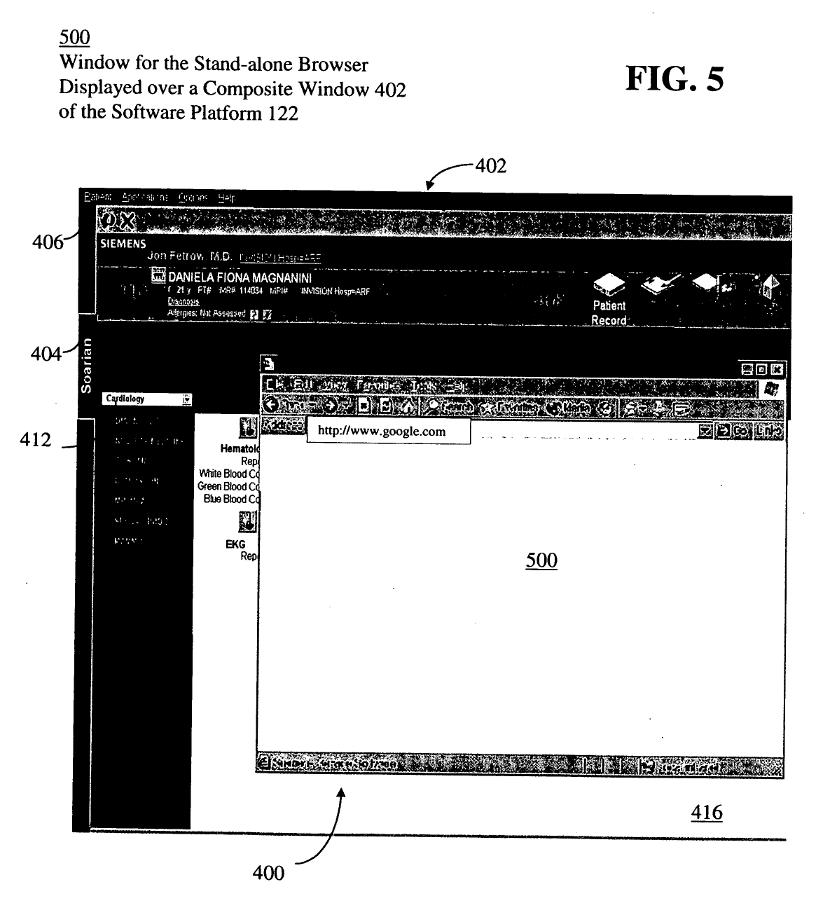

At step 215, the stand-alone browser 128 opens a web document, corresponding to the URL link 121, in a window 500, as shown in FIG. 5, associated with the stand-alone browser 128.

At step 216, the user works in the window 500 of the stand-alone browser 128, closes the window 500, and continues working in the window 400, as shown in FIG. 4, associated with the first executable application 126, per step 233.

As an alternative embodiment to steps 214-216, a local web server, functioning in a similar manner to a Web proxy server, intercepts URL navigations to a particular Web application server. A navigation attempted to a certain server, such as, for example, http://www.google.com, would be redirected to a local computer using the computer's host file. This alternate embodiment involves security concerns when dealing with secure Web connections, and the overhead of controlling the local computer web services, which could potentially conflict with other services running on the computer.

At step 217, the monitor 152 prevents the stand-alone browser 128 from navigating to the URL link 120, in response to the monitor 152 determining that the second embedded browser 142 is permitted to navigate to the URL link 120. Alternatively, the communicator 153 terminates the establishment of the browser session 138 in the stand-alone browser 128 by preventing unauthorized (i.e., unacceptable) URL navigations from occurring in the first place. Hence, the BHO 146 does not start, because the stand-alone browser 128 does not start. However, this method provides few opportunities to know that the stand-alone browser 128 attempted navigation, which may lead to some loss of functionality in the first executable application 122.

At step 218, the stand-alone browser 128 does not open a web document, corresponding to the URL link 120, in the window 500 associated with the stand-alone browser 128.

At step 219, the method 200 continues from step 218 to step 220 between pages.

At step 220, the communicator 153 in the browser helper object 146 creates a Windows compatible message including the URL link 120, and searches for the second executable application 130 hosting the second embedded browser 142.

At step 221, the communicator 153 sends the Windows compatible message, including the URL link 120, to the receiving component 148, associated with the second executable application 130. In particular, the BHO 146 uses Win32 Window hierarchy functions, which are well known to those skilled in the art, to send the message, as described in the following known functions.

The GetWindow function is used in conjunction with the GetDesktopWindow function to retrieve the first top-level window handle directly under the desktop window. After the handle is retrieved, it is possible to loop through each top-level window handle while checking each window's title using the GetWindowText function. When a window title contains a keyword that identifies a top-level window, the GetWindowText function searches the child windows under the top-level window by using the EnumChildWindows function. The EnumChildWindows function calls an application-supplied callback function for each child window of the proprietary user interface system top-level window.

The application-supplied callback function uses the GetWindowText function to attain the child window's title. If the child window's title matches a target key defined from a configuration file, the SendMessage function is used in conjunction with a pre-defined Window's message (e.g., WM_COPYDATA). This allows a string of information stored in the pre-defined Window's data structure (e.g., COPYDATASTRUCT) to be sent to the target child window.

The follow software code provides an example for retrieving a handle for a top-level window.

HWND hWnd = GetWindow(GetDesktopWindow( ),GW_CHILD);
TCHAR tCName[100];
int failsafe = 0; //prevent infinite loops
while(hWnd && failsafe < 1000) //loop through windows directly under main

Desktop

{

GetWindowText(hWnd,tCName,100); //get window title
CString CCName(tCName);
for(int i=0;i<m_proprietary user interface systemHandleArray.GetSize( );i++)
{

if(CCName.Find(m_proprietary user interface

systemHandleArray.GetAt(i)) >= 0) //if this is a proprietary user interface system parent

if (hWnd)
{

EnumChildWindows(hWnd, EnumChildProc, //search

child windows

(LPARAM)Message.GetBuffer(Message.GetLength( ))

);

}

}
hWnd = GetWindow(hWnd,GW_HWNDNEXT); //go to next window
failsafe++;

}

The follow software code provides an example for retrieving a handle to a child window under the top-level window, and sending the Windows compatible message.

BOOL CALLBACK CIEHlprObj::EnumChildProc(HWND hwndChild, LPARAM lParam)

{

TCHAR tCName[100];
CString strRecievedText = (LPCSTR)lParam; //get Cstring message from

lParam

if(strRecievedText.Find(“|”) >= 0)
{ //parse message to attain target proprietary user interface system child

app and message to be sent

CString theMessage = “proprietary user interface

systemSpy|”+strRecievedText.Mid(0,strRecievedText.Find(“|”));

Cstring childApp =

strRecievedText.Mid(strRecievedText.Find(“|”)+1);

if(hwndChild != NULL)
{

::GetWindowText(hwndChild,tCName,100);
CString CCName(tCName);
if(CCName == childApp) //if child title matches target
{

COPYDATASTRUCT cpd;
cpd.dwData = 0;
cpd.cbData = theMessage.GetLength( );
cpd.lpData =(void*)theMessage.GetBuffer(cpd.cbData);

//send message

::SendMessage(hwndChild,WM_COPYDATA,NULL,(LPARAM)&cpd);

}

}

}
return TRUE;

}

At step 222, the communicator 153 terminates the browser session 138 in the stand-alone browser 128, and terminates the BHO 146.

At step 223, the receiving component 148 receives the Windows compatible message, including the URL link 120, in response to, in particular, the SetWindowText function assigning the receiving class a known title that the second executable application 130 recognizes.

At step 224, the receiving component 148 communicates the URL link 120 to the second executable application 130. In particular, the second executable application 130 implements a WM_COPYDATA function allowing it to receive the COPYDATASTRUCT sent from the receiving component 148. When this function is invoked, the string is retrieved from the COPYDATASTRUCT and converted to a CString. The string is constructed in a format for the second embedded browser to parse it at step 225, and to navigate to the parsed URL 120 at step 226. The following is example of a string format for the Windows compatible message received from the BHO 146: “proprietary user interface system|<URLTOBENAVIGATEDTO>.” An example of a particular string is: “:proprietary user interface system|http://www.google.com.”

The follow software code provides an example for receiving the Windows compatible message from the BHO 146.

WM_COPYDATA member function

BOOL TASKCARDDlg::OnCopyData(CWnd* pWnd, COPYDATASTRUCT*

pCopyDataStruct)

{

CString strRecievedText = (LPCSTR) (pCopyDataStruct->lpData); //retrieve

string from CopyDataStruct

strRecievedText = strRecievedText.Mid(0,pCopyDataStruct->cbData);
if(strRecievedText.Find(_T(“proprietary user interface systemSpy”)) >= 0) //if

from proprietary user interface systemSpy

{

CString Url = strRecievedText.Mid(strRecievedText.Find(_T(“|”))+1);

//parse out URL

NavigateBrowser(Url); //navigate Web Browser to URL

}

return CDialog::OnCopyData(pWnd, pCopyDataStruct);

}

At step 225, the second embedded browser 142, associated with the second executable application 130, starts a browser session 144 in response to receiving the URL link 120.

At step 226, the second embedded browser 142 navigates to the URL link 120.

At step 227, the method 200 continues from step 226 to step 228 between pages.

At step 228, the second embedded browser 142 opens a web document 604, corresponding to the URL link 120, in a window 600, as shown in FIG. 6, associated with the second executable application 130.

At step 229, the window 600, associated with the second embedded browser 130, displays the web document 604, corresponding to the URL link 120, in the foreground of the composite image 402 of the software platform, thereby overlaying the window 400, associated with the first embedded browser 126. To the user of the first executable application 118, it appears that the first executable application 122 has directly instructed the second executable application 130 to navigate to the URL 120, rather than being communicated through the stand-alone browser 128 with the assistance of the BHO 146 and the receiving component 148.

At step 230, the user works in the window 600, as shown in FIG. 6, associated with the second embedded browser 130, which displays the web document 604, corresponding to the URL link 120.

At step 231, the user identifies and selects the tab 404, as shown in FIG. 4, 5, and 6, corresponding to the window 400, associated with the first executable application 126.

At step 232, the software platform 122 moves the window 400, as shown in FIG. 4, associated with the first executable application 126, to the foreground of the composite image 402 of the software platform 122, thereby overlaying the window 600, as shown in FIG. 6, associated with the second executable application 130.

At step 233, the user continues working in the window 400, as shown in FIG. 4, associated with the first executable application 126.

At step 234, the method ends.

FIG. 3 illustrates a conceptual flow diagram 300 for the system 100, as shown in FIG. 1, and the method 200, as shown in FIG. 2. The diagram 300 includes, from the system 100 of FIG. 1, the first executable application 126, the second executable application 130, the stand-alone browser 128, the browser helper object (BHO) 146, and the receiving component 148. The diagram 300 further illustrates the steps of FIG. 2.

The first executable application 126 is associated with steps 201-207, and steps 231-233. The second executable application 130 is associated with steps 201-204, and steps 225-230. The stand-alone browser 128 is associated with steps 212, 215, 216, and 218. The browser helper object (BHO) 146 is associated with steps 209, 213, 214, 217, 220, and 222. The receiving component 148 is associated with steps 223.

The communication from the first executable application 126 to the stand-alone browser 128 is associated with step 208. The communication between the browser helper object (BHO) 146 and the stand-alone browser 128 is associated with step 211. The communication from the browser helper object (BHO) 146 and the receiving component 148 is associated with step 221. The communication from the receiving component 148 and the second executable application 130 is associated with step 224.

FIG. 4 illustrates a window 400 for the first executable application 126, as shown in FIG. 1, displayed in a composite window 402 of the software platform 122, as shown in FIG. 1. The composite window 402 includes a first tab 404 associated with the window 400 for the first executable application 126, and a second tab 406 associated with a window 600, as shown in FIG. 6, for the second executable application 130. The window 400 further includes icons 408, patient identification information 410, a menu 412, and a display area 414.

The composite image 402 of the software platform 122 is the same in FIGS. 4, 5, and 6. The composite image 402 provides a frame or a window that displays information related to the software platform 122, such as, for example, information for the first executable application 126 and/or the second executable application 130. The information includes, for example, control information, such as menus, icons, and URLs, and result information, such as in the form of a document, graphics, audio, and/or video.

In the composite image 402, as shown in FIG. 4, the window 400 for the first executable application 126 overlays the window 600, as shown in FIG. 6, for the second executable application 130. The software platform 122 displays the windows 400 and 600 in such as manner that the window 400 completely overlays the window 600, for example. Alternatively, the software platform 122 may display the windows 400 and 600 in such as manner that the window 400 does not completely overlay the window 600, if required or desired.

Each window 400 and 600 includes a visible tab 404 and 406, respectively, incorporating an identifier identifying a respective window 400 and 600, respectively. The identifier may be a name, such as, for example, Soarian or EKG, for the window or executable application. The identifiers change their appearance to indicate which window is in the foreground of the composite image 402. For example, the indicator in the tab 404 is highlighted when the window 400, as shown in FIG. 4, for the first executable application 126 is in the foreground of the composite image 402. Alternatively, the indicator in the tab 406 is highlighted when the window 600, as shown in FIG. 6, for the second executable application 130 is in the foreground of the composite image 402.

The first tab 404 is associated with the window 400 for the first executable application 126. The second tab 406 is associated with a window 600, as shown in FIG. 6, for the second executable application 130. Each tab 404 and 406 is selectable by the user of the software platform 122, such as, for example, by positioning a cursor over the tab and clicking the mouse. The software platform 122 brings the window 400 for the first executable application 126 to the foreground (i.e., overlaying the window 600 for the second executable application 130) of the composite image 402, in response to the user selecting the first tab 404. The software platform 122 brings the window 600 for the second executable application 130 to the foreground (i.e., overlaying the window 400 for the first executable application 126) of the composite image 402, in response to the user selecting the second tab 406.

A user interface system-based task card represents a combination of a window and a tab. For example, a first user interface system-based task card represents a combination of the window 400 and the tab 404, and a second user interface system-based task card represents a combination of the window 600 and the tab 406. The system 100 includes a first user interface system-based task card hosting the first executable application 126, and a second user interface system-based task card hosting the second executable application 130.

The icons 408 represent various parts of the first executable application 126, such as, for example, patient records, charting, orders, and visit. Like the tabs 404 and 406, the icons 408 are selectable by the user.

The patient identification information 410 provides information about a particular patent, such as, for example, a name, sex, age, etc. The patient identification information 410 associates a particular patient to information displayed by the first executable application 126 in the display area 414.

The menu 412, such as cardiology, for example, provides various user selectable topics related to the first executable application 126. A particular topic corresponds to information displayed by the first executable application 126 in the display area 414.

The display area 414 provides a region in the window 400 where the first executable application 126 displays information. The information includes, for example, results related to the particular patient, and includes, for example URL links 120 and/or 121.

The URL 120 link (e.g., http://MegaCareServer/Results.asp?pid=114034) represents a user selectable link or connection to a web page in the window 600, as shown in FIG. 6, for the second executable application 130. The URL 120 link (e.g., http://www.google.com) represents a user selectable link or connection to a web page in a window 500, as shown in FIG. 5, for the stand-alone browser 128.

FIG. 5 illustrates a window 500 for the stand-alone browser 128, as shown in FIG. 1, displayed over a composite window 402 of a software platform 122, as shown in FIG. 1. The window 500 appears in the foreground (i.e., overlaying the composite image 402) of the composite image 402. The stand-alone browser 128 permits the user to navigate among one or more web pages, corresponding to the URL 121 or other URLs, in the window 500. When the user is finished navigating in the window 500, the user may close the window 500, or click on the composite window 402 to bring the composite window 402 to the foreground (i.e., overlaying the window 500).

FIG. 6 illustrates a window 600 for the second executable application 130, as shown in FIG. 1, displayed in a composite window 402 of a software platform 122, as shown in FIG. 1. The window 600 includes a display area 604, patient identification information 606, and result information 608.

In the composite image 402, as shown in FIG. 6, the window 600 for the second executable application 130 overlays the window 400, as shown in FIG. 4, for the first executable application 126. The software platform 122 displays the windows 400 and 600 in such as manner that the window 600 completely overlays the window 400, for example. Alternatively, the software platform 122 may display the windows 400 and 600 in such as manner that the window 600 does not completely overlay the window 400, if required or desired.

The display area 604 provides a region in the window 600 where the second executable application 130 displays information. The information includes, for example, results related to the particular patient.

The patient identification information 606 provides information about a particular patient, such as, for example, a name, sex, age, etc. The patient identification information 606 associates a particular identified patient to information displayed by the second executable application 130 in the display area 604.

The result information 608 provides information about a particular patient, such as, for example, test results, lab results, reports, examination information, etc. For example, the result information 608 in the display area 604 represents a graph of a particular patients test results. Hence, in response to a user selecting the URL 120, the second executable application 130 displays the window 600 including the patent identification information and the result information 608 in the display area 604.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A system for managing operating sessions of an executable application initiated via a browser application on a workstation, comprising:
a detector for detecting initiation of a first operational session of an executable application on a workstation, said initiation occurring in response to user activation of a displayed URL link;
a monitor for determining whether a previously initiated second operational session of said executable application is concurrently operational on said workstation by comparing at least a portion of said URL with stored data representing one or more URLs corresponding to one or more executable applications currently operational on said workstation;
a command processor for redirecting said first operational session to a URL of said previously initiated second operational session of said executable application, in response to a URL match determined by said comparison; and
a communicator for terminating establishment of said first operational session.

2. A system according to claim 1, wherein
said first operational session of said executable application comprises a replicated instance of a browser application.

3. A system according to claim 1, wherein
said first operational session of said executable application comprises a replicated instance of an executable application accessed via a browser application.

4. A system according to claim 1, wherein
said monitor compares said at least a portion of said URL link with stored data representing one or more URL links by comparing at least one of, (a) words, (b) phrases, and (c) character strings of URLs.

5. A system according to claim 1, wherein
said stored data represents a prohibited URL; and
said communicator terminates establishment of said first operational session, in response to said URL matching said prohibited URL determined by said comparison.

6. A system for preventing initiation of replicated operating sessions of an executable application initiated via a browser application on a workstation according to claim 1, wherein
said stored data represents one or more URLs corresponding to a plurality of overlaid tabbed web page windows corresponding to a plurality of executable applications currently operational on said workstation.

7. A system according to claim 6, wherein
said plurality of overlaid tabbed web page windows each include a visible tab incorporating an identifier identifying a respective web page.

8. A system according to claim 1, wherein
said stored data represents one or more URLs corresponding to a plurality of overlaid tabbed web page windows corresponding to a plurality of executable applications currently operational on said workstation; and
in response to said redirecting of said first operational session to said URL of said previously initiated second operational session of said executable application,
said command processor initiates display of a web page corresponding to said previously initiated second operational session of said executable application in the foreground of a composite image comprising said overlaid tabbed web page windows.

9. A system for managing operating sessions of an executable application initiated via a browser application on a workstation, comprising:
a detector for detecting initiation of a first operational session of an executable application on a workstation, said initiation occurring in response to user activation of a displayed URL link;
a monitor for determining whether a previously initiated second operational session of said executable application is concurrently operational on said workstation by comparing at least a portion of said URL with stored data representing one or more URLs corresponding to a plurality of applications and having a corresponding plurality of overlaid tabbed web page windows on said workstation; and a command processor for initiating display of a web page corresponding to said previously initiated second operational session of said executable application in the foreground of a composite image comprising said overlaid tabbed web page windows, in response to a URL match determined by said comparison; and
a communicator for terminating establishment of said first operational session.

10. A system according to claim 9, wherein
said command processor redirects said first operational session to a URL of said previously initiated second operational session of said executable application in response to said URL match.

11. A method for managing operating sessions of an executable application initiated via a browser application on a workstation, comprising the steps of:
detecting initiation of a first operational session of an executable application on a workstation, said initiation occurring in response to user activation of a displayed URL link;
determining whether a previously initiated second operational session of said executable application is concurrently operational on said workstation by comparing at least a portion of said URL with stored data representing one or more URLs corresponding to one or more executable applications currently operational on said workstation;
redirecting said first operational session to a URL of said previously initiated second operational session of said executable application, in response to a URL match determined by said comparison; and
terminating establishment of said first operational session.

12. A method for managing operating sessions of an executable application initiated via a browser application on a workstation, comprising the steps of:
detecting initiation of a first operational session of an executable application on a workstation, said initiation occurring in response to user activation of a displayed URL link;
determining whether a previously initiated second operational session of said executable application is concurrently operational on said workstation, by comparing at least a portion of said URL with stored data representing one or more URLs corresponding to a plurality of applications and having a corresponding plurality of overlaid tabbed web page windows on said workstation;
initiating display of a web page corresponding to said previously initiated second operational session of said executable application in the foreground of a composite image comprising said overlaid tabbed web page windows, in response to a URL match determined by said comparison; and
terminating establishment of said first operational session.
